(19) United States
(12) Patent Application Publication
(10) Pub. No.: US 2017/0053222 A1
(43) Pub. Date: Feb. 23, 2017

(54) ROLE BASED ASSESSMENT FOR AN IT MANAGEMENT SYSTEM

(71) Applicant: HEWLETT PACKARD ENTERPRISE DEVELOPMENT LP, Houston, TX (US)

(72) Inventors: Inbar Shani, Yehud (IL); Amichai Nitsan, Yehud (IL); Dror Saaroni, Yehud (IL)

(21) Appl. No.: 15/118,952

(22) PCT Filed: Feb. 19, 2014
(86) PCT No.: PCT/US14/17160

§ 371 Date: Aug. 15, 2016

(51) Int. Cl. G06Q 10/06; G06F 17/30

(52) U.S. Cl. CPC G06Q 10/06313; G06F 17/30312

(57) ABSTRACT

Role based assessment for an IT management system, includes maintaining a plurality of roles, each role attributable to a user type within an IT management system. Mappings are defined between the plurality of user roles and assets of the IT management system. An assessment for the IT management system is then assembled from the perspective of a selected one of the plurality of roles based on mappings between the selected user role and the assets.

### BACKGROUND

IT (Information Technology) management systems come in a variety of flavors. As examples, some are designed to manage lifecycles of software applications. Some are used to manage and monitor business services such as application and system performance within an IT infrastructure. Others are used to manage IT services. In each case, an IT management system can be utilized to generate reports for assessing impacts of the assets being managed.

### DRAWINGS

FIG. 1 depicts an example of a data structure for use in role base assessments for an IT management system.

FIG. 2 depicts an example of a data structure for use in role base assessments for an application lifecycle management system.

FIG. 3 is a block diagram depicting an example of a system for role based assessment for an IT management system.

FIG. 4 is a block diagram depicting example contents of a data repository.

FIG. 5 is a block diagram depicting a memory resource and a processing resource according to an example.

FIG. 6 is a flow diagram depicting actions taken to implement an example.

### DETAILED DESCRIPTION

### Introduction

When interacting with an IT management system, different users function in different roles. Users in different roles are often interested in and affected by different aspects of assets managed by that IT management system. From a quality perspective, users of different roles may have different perceptions of an application managed by an application lifecycle management system. From a performance perspective, users of different roles may have different perceptions of an IT infrastructure managed by a business service management system.

As an example, users of different roles may utilize different workflows within an application. Thus, defects recorded in an application lifecycle management system can affect different users differently. Where a defect impacts a workflow associated with a given role but not another, a quality assessments for the application can differ between those two roles. With respect to an infrastructure performance management system, users in different roles may be interested in different aspects of the infrastructure. One role may be interested in storage performance while another in server response times. Where an incident impacts an infrastructure aspect associated with a given role but not another, a performance assessment for the IT infrastructure can differ between those two roles.

Various examples described below can be used to establish and maintain mappings between user roles within an IT management system and the various assets managed by that system. Those mappings can then be used to generate role based assessments for the IT management system. Different IT management systems manage different types of assets. For example an application lifecycle management system might manage, among other items, tests, user stories, and defects. A business service management system might manage incidents and correlations for mapping incidents to infrastructure failures or other issues. The mappings, as explained in more detail below, define a number of relationships and can extend between a user role and an asset, between a user trait and an asset, and between a user role and a user trait.

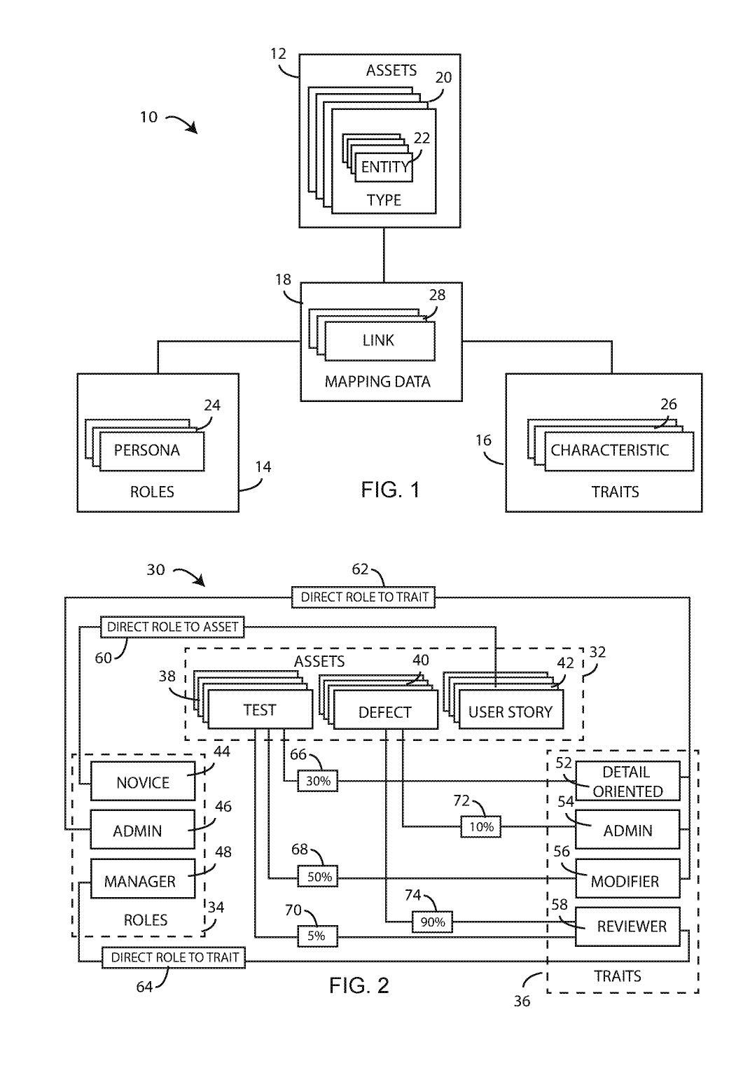

To aid in discussion, FIG. 1 is a block diagram depicting mappings between assets, roles, and traits for a generic IT management system. FIG. 2 is a block diagram depicting example mappings for an application lifecycle management system. Starting with FIG. 1, mapping data structure 10 includes assets 12, roles 14, traits 16, and mapping data 18. Assets 12, in this example are segmented by type 20 and further by entity 22. A given IT management system may manage items of varying types 20. Individual items within a given type 2 are depicted as entities 22. As will be describe with reference to FIG. 2, an application lifecycle management system might manage asset types 20 such as tests, defects and user stories. Here, each individual test, defect, and user story is represented by a corresponding entity 22.

As noted, users of an IT management system fall into different persona and can be divided into categories or types. Roles 14, include a number of defined persona 24. Each persona 24 represents data indicative of a type of user within the IT management system. Such a user may be a user of the IT management system itself or a user of an asset managed or otherwise affected by the IT management system. Users can also have shared characteristics. Traits 16 include a number of characteristics 26. Each characteristic 26 represents data indicative of a trait type that can be used to describe a user in a given role.

Mapping data 18 includes links 28. Each link 28 represents data indicative of a mapping or association between any of assets 12 and roles 14; assets 12 and traits 16; and roles 14 and traits 16. The mapping to an asset 12 is, in the example of FIG. 1, a link to a selected asset type 20 or to a selected entity 22. A mapping to a role 14 is a link to a selected persona 24, and a mapping to a trait 16 is a link to a selected characteristic 26. In this way, an asset 12 can be directly associated with a role 14 or indirectly via a trait 16. Where multiple roles 14 are associated with the same trait 16, an indirect association can exist between a given asset 12 and those multiple roles 14. In addition to defining an association between two elements, each link 28 may also include a weight for use in specifying a relative strength of the association. This weight can quantify the strength of an association between a role 24 and a trait 26, between an asset 12 and a role 24, and between an asset 12 and a trait 26.

FIG. 2 depicts an example use case for an application lifecycle management system. The data 30 here is grouped by assets 32, roles 34, and traits 36. Assets 32 are divided into groups of individual tests 38, defects 40, and user stories 42. Roles 34 are divided into the personas of novice 44, admin 46, and manager 48. Traits 36 are identified as detail oriented 52, admin 54, modifier 56, and reviewer 58. The mapping data in FIG. 2 is represented by links 60-74 between assets 32, roles 34, and traits 36.

In the Example of FIG. 2, the user story 22 asset type is associated directly via link 60 with the role of novice 44 indicating a predicted interest of novice users with all user stories 42. The role of admin 46 is associated with traits 52, 54, and 56 via a set of mappings represented as link 62. The manager role 48 is mapped to the reviewer trait 58 via link 64. A selected test entity 38 is mapped to traits 52, 54, and 58 via respective links 66, 68, and 70. A selected defect entity 40 is mapped to traits 54 and 58 via respective links 72 and 74. Each link 66-74, in this example, includes a weight specified as a percentage that quantifies a relative strength of the corresponding mapping. As roles 34 are also linked to traits 36, the weights can be used to determine the relative strength of an indirect link between an asset 32 and a role 34. Here there is a relatively strong link between the test entity asset 38 and the admin role 46. There is a weaker indirect link between the same test entity asset 38 and the manager role 48, but a stronger indirect link between the manager role 48 and the selected defect entity asset 40.

The mapping data 18 of FIG. 1 and the corresponding links 60-74 of FIG. 2 can be used to generate an assessment for an underlying IT management system based on user roles. The assessment may be based on an evaluation of assets directly and indirectly mapped to a given role and the relative strengths of those mappings. With respect to the underlying application lifecycle management system of FIG. 2, that assessment may be a quality assessment for a given application based on an evaluation of those assets directly and indirectly mapped to a given role and the relative strengths of those mappings. For a different IT management system, that assessment may focus on different role based qualities using a similar evaluation. An assessment for a business service management system may focus an assessment on role based performance. An assessment for an IT service management system may focus on role base service metrics.

Components

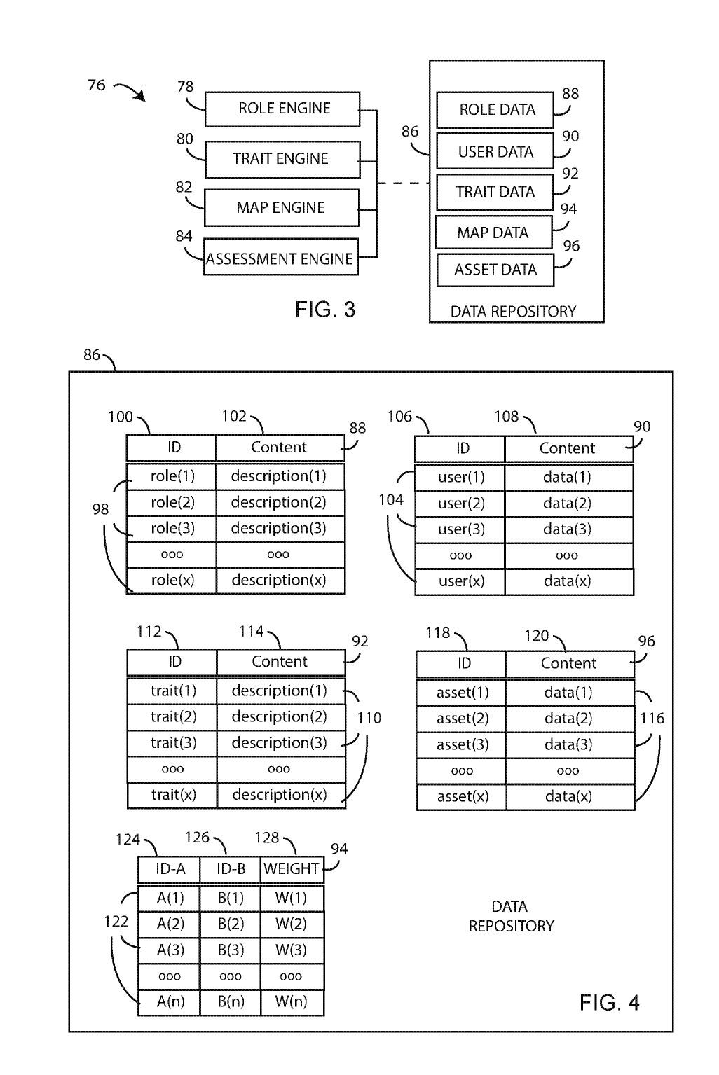

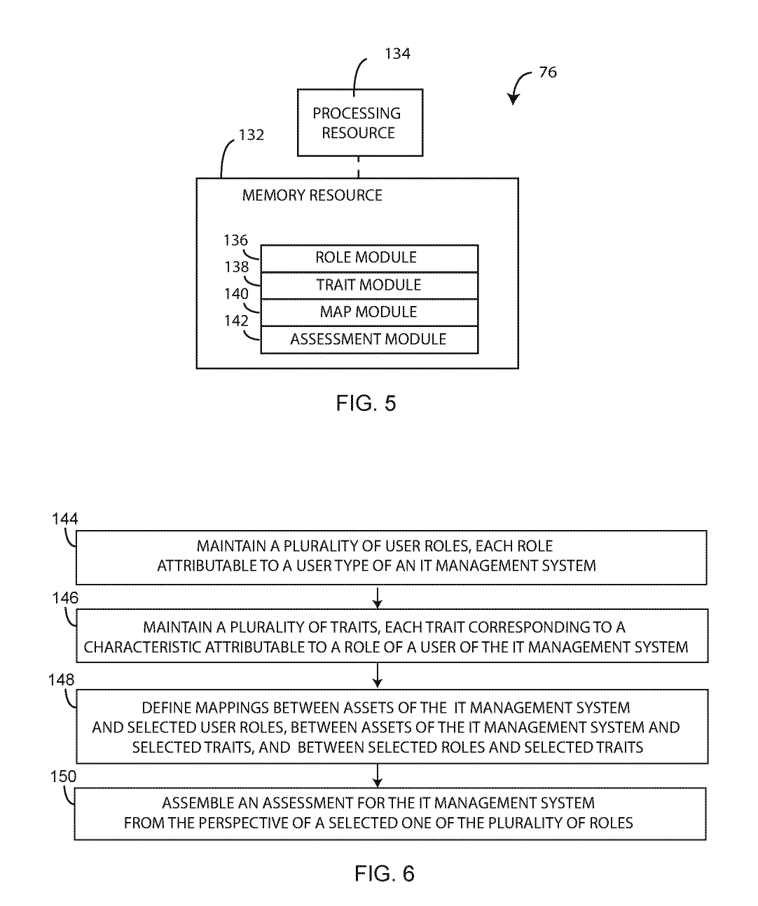

FIGS. 3-5 depict examples of physical and logical components for implementing a role based assessment engine 76. In FIG. 3 various components are identified as engines 78-84. In describing engines 78-84, focus is on each engine's designated function. However, the term engine, as used herein, refers to a combination of hardware and programming configured to perform a designated function. As is illustrated later with respect to FIG. 5, the hardware of each engine, for example, may include one or both of a processor and a memory device, while the programing is code stored on that memory device and executable by the processor to perform the designated function.

FIG. 3 is a block diagram depicting components of role based assessment system 76. In this example, system 76 includes role engine 78, trait engine 80, map engine 82, and report engine 84. In performing their respective functions, engines 78-84 may access data repository 86. Repository 86 represents generally any memory accessible to system 76 that can be used to store and retrieve data.

Role engine 78 is configured to maintain a plurality of roles each defining a type or category of user within an IT management system. As discussed, such a user may be a user of the IT system itself or a user of an asset managed or otherwise affected by the IT management system. Each role, for example, may be identified in role data 88 and associated with one or more users identified in user data 90. Roles may be default roles or user defined roles. In maintaining roles, role engine 78 is responsible for adding to or modifying role data 88. Role data 88 represents data identifying a set of roles and a description of each. Examples of roles were discussed above with respect to FIGS. 1 and 2.

Trait engine 80 is configured to maintain a plurality of traits each defining a particular characteristic that can be used to define a user within an IT management system. Each trait, for example, may be identified in trait data 92. Traits may be default traits or user defined traits. In maintaining traits, trait engine 80 is responsible for adding to or modifying trait data 90. Trait data 90 represents data identifying a set of traits and a description of each. Examples of traits were discussed above with respect to FIGS. 1 and 2.

Map engine 82 is configured to establish mappings between assets of an IT management system and roles maintained by role engine 78, between those assets and traits maintained by trait engine 80, and between those roles and traits. Mappings established by map engine 82 are maintained as map data 94. The assets, in the example of FIG. 3, are assets defined or otherwise identified in asset data 96. As described above with respect to FIGS. 1 and 2, map engine 82 may assign each mapping a weight. Map engine 82 may be manually manipulated by a user to establish mappings. As will be described below, map engine 82 may also operate in an automatic mode where it generates mappings without user input and in a semi-automatic mode where it suggests mappings to a user.

Assessment engine 84 is configured to perform a role based evaluation for an IT management system. In performing this task, assessment engine 84 may, for a selected role identified in role data 88, identify assets from asset data 96 that are directly and indirectly linked to that role. Evaluating the relative weights of those links and the contents of the linked assets, assessment engine 84 can generate an assessment for the IT management system from the perspective of the selected role. Using the example of the application lifecycle management system of FIG. 2, asset data 96 may include a number of defects. Where map data 94, directly or indirectly links those defects to a particular user role. Assessment engine 84 can report a quality based assessment for that role that is directly impacted by those defects and not others. In performing its function, assessment engine 84 may generate and communicate electronic content that can be processed to generate a display that presents the assessment.

FIG. 4 is a block diagram depicting an example of a data structure of the contents of data repository 86. Role data 88 is represented as a table containing a series of rows or entries 98 each representing a given role maintained by role engine 78. Each entry 98 includes data in an ID field 100 and a content field 102. Data in ID field 100 represents any identifier that can be used to define a mappings between a role represented by a given entry 98 and other items such as users, assets, and traits. Data in content field 102 provides a name and description of the role and any other useful information associated with the role.

User data 90 is represented as a table containing a series of rows or entries 104 each representing a given user within the IT management system. User data 90 may be a company directory or be linked to such a directory. Each entry 104 includes data in an ID field 106 and a content field 108. Data in ID field 106 represents any identifier that can be used to define mappings between a user represented by a given entry 104 and a role defined in role data 88. Data in content field 108 for each entry 104 provides additional details about the user associated with that entry 104. These additional details can be analyzed to identify similarities between users mapped to a given role. Thus, when a new user is added to user data 90, data in content field 108 for that user can be examined, and the user can be automatically mapped to a role or a suggestion can be made to do so based on similarities with other users mapped to the same role.

Trait data 92 is represented as a table containing a series of rows or entries 110 each representing a given trait maintained by trait engine 80. Each entry 110 includes data in an ID field 112 and a content field 114. Data in ID field 112 represents any identifier that can be used to define mappings between a trait represented by a given entry 110 and other items such as assets and roles. Data in content field 114 provides a name and description of the trait and any other useful information associated with the trait.

Asset data 96 is represented as a table containing a series of rows or entries 116 each representing a given asset managed by the IT management system. Asset data 96 may include the content of all such assets or it may include links to other data sources containing those assets. For example, where a given asset is a test managed by an application lifecycle management system, asset data 96 may include all the information regarding that test, or it may include a link for accessing that data from another source. Each entry 116 includes data in an ID field 118 and a content field 120. Data in ID field 118 represents any identifier that can be used to define mappings between an asset represented by a given entry 116 and other items such as roles identified in role data 88 and traits identified in trait data 92. Data in content field 120 for each entry 104 provides additional details about the asset associated with that entry 116. These additional details may include information defining the asset being managed or a link for accessing such information from another source. The data in field 116 can then be used to identify similarities between assets mapped to a given role or trait. Thus, when a new asset is added to asset data 90, data in content field 120 for that asset can be examined, and the asset can be automatically mapped to a given role or trait or a suggestion can be made to do so based on similarities with other assets mapped to that given role or trait. The same can occur as mapping data 94 is populated over time. With additional mappings defined, it can become possible to identify common mappings between similar assets and roles or traits. Thus map engine 82 may continually evaluate map data 94 to identify such common mappings and examine asset data 106 to identify a similar asset not yet mapped. Upon finding matches, map engine 82 may suggest a mapping or automatically define one.

Map data 94 is represented as a table containing a series of rows or entries 122 each representing a mapping between two items such as a user and a role, an asset and a role, an asset and a trait, and a role and a trait identified in role, user, trait, and asset data 88-96. Each entry 122 includes data in ID fields 124 and 126 as well as data in weight field 128. Data in ID fields 124 and 126 of a given entry 122 represent the identifiers for the two items being mapped. For example, these can be the corresponding identifiers from ID fields 100, 106, 112, and 118 of role data 88, user data 90, trait data 92 and asset data 96. Data in weight field 128 of a given entry 122 represents a value associated with a corresponding mapping. This value, when compared to values assigned to other mappings, can be used to determine a relative strength of the mapping. For example, a given asset may be mapped to two roles. However, the mapping to one role may be stronger than the mapping to the other.

As discussed above, map engine 82 may be used to manually map items to one another. Here, via a user interface, a user would select two items such as a role and a trait, a role and an asset, or an asset and a trait and provide an instruction to map engine 84 to map the selected items. Map engine 82 would respond by adding a new entry 122 to map data 94 that includes the relevant identifiers for those items as well as a user specified weight value. Alternatively, map engine 82 may recognize a new asset added to asset data 96. Map engine 82 may then examine information that defines or is otherwise associated with that asset to identify other similar assets in asset data 96. For example, the new asset may be a defect associated with a particular control on a given screen of a user interface for a given application. Map engine 82 may then identify other defects related to the same application, the same screen, and the same control. If those defects share a common mapping to a role or a trait, map engine 82 may automatically map the new asset to such a role or trait, or it may cause a suggestion to be presented to a user to establish such a mapping.

In the foregoing discussion, engines 78-84 were described as combinations of hardware and programming. Engines 78-84 may be implemented in a number of fashions. Looking at FIG. 5, the programming may be processor executable instructions stored on tangible memory resource 132 and the hardware may include processing resource 134 for executing those instructions. Thus memory resource 132 can be said to store program instructions that when executed by processing resource 134 implements system 76 of FIG. 3.

Memory resource 132 represents generally any number of memory components capable of storing instructions that can be executed by processing resource 134. Memory resource 132 is non-transitory in the sense that it does not encompass a transitory signal but instead is made up of more or more memory components configured to store the relevant instructions. Memory resource 132 may be implemented in a single device or distributed across devices. Likewise, processing resource 134 represents any number of processors capable of executing instructions stored by memory resource 132. Processing resource 134 may be integrated in a single device or distributed across devices. Further, memory resource 132 may be fully or partially integrated in the same device as processing resource 134, or it may be separate but accessible to that device and processing resource 134.

In one example, the program instructions can be part of an installation package that when installed can be executed by processing resource 134 to implement system 76. In this case, memory resource 132 may be a portable medium such as a CD, DVD, or flash drive or a memory maintained by a server from which the installation package can be downloaded and installed. In another example, the program instructions may be part of an application or applications already installed. Here, memory resource 132 can include integrated memory such as a hard drive, solid state drive, or the like.

In FIG. 4, the executable program instructions stored in memory resource 58 are depicted as role, trait, map, and assessment modules 136-142 respectively. Role module 136 represents program instructions that, when executed, cause processing resource 134 to implement role engine 78. Trait module 138 represents program instructions that, when executed, cause processing resource 134 to implement trait engine 80. Map module 140 represents program instructions that, when executed, cause processing resource 134 to implement map engine 82. Assessment module 142 represents program instructions that, when executed, cause processing resource 134 to implement assessment engine 84.

Operation

FIG. 6 is a flow diagram of actions taken to implement a method for evaluating user interface efficiency. In discussing FIG. 6, reference may be made to components depicted in FIGS. 1-5. Such reference is made to provide contextual examples and not to limit the manner in which the method depicted by FIG. 6 may be implemented.

A plurality of user roles are maintained (block 144). Each role is attributable to a user type within an IT management system. The user type may correspond to a user of the IT management system itself or a user of an asset managed or otherwise affected by the IT Management system. Referring to FIG. 3, role engine 78 may be responsible for block 144. Maintaining, in this example can include creating, updating, and accessing role data 88 of FIGS. 3 and 4. A plurality of traits are maintained (block 146). Each trait corresponds to a characteristic attributable to a role of a user within the IT management system. Referring to FIG. 3, trait engine 80 may be responsible for block 146. Maintaining, in this example can include creating, updating, and accessing trait data 92 of FIGS. 3 and 4.

Direct and indirect mappings are defined between assets of the IT management system and the roles maintained in block 144 (block 148). The direct mappings are direct links between selected assets and selected roles. Block 148 can include mapping roles to traits and assets to traits such that the assets are indirectly mapped to the roles via shared trait mappings. Defining a mapping can also include assigning a weight or value that can be used to discern a relative strength of the mapping when compared to other mappings. Referring to FIG. 3, map engine 82 may be responsible for block 148. Defining a mapping, in this example can include creating, updating, and accessing map data 94 of FIGS. 3 and 4.

Mappings may be defined in block 144 based on user input identifying the items to be mapped and a corresponding weight. Mappings may be defined in a semi-automatic fashion where, upon entry or modification of an asset, a mapping of the asset to a role or trait is suggested to a user based on a similarity of that asset to other mapped assets. A mapping can also be defined automatically, for example, where the new asset differs from the others by less than a specified threshold. For example, new defect asset may correspond to the same UI screen of the same application as another defect mapped to a given role or trait. Here the new defect may be automatically mapped to that same role or trait.

An assessment is then assembled for the IT management system from the perspective of a selected one of the roles maintained in block 144 (block 150). The assessment may be a report assembled by identifying direct and indirect mappings between the selected role and assets of the IT management system. Weights associated with those mappings may also be taken into account. The report can then be focused on metrics associated with the mapped assets and adjusted according to those associated weights. Continuing with the example of the application lifecycle management system, the, the quality of an application managed by the system can be assessed from the perspective of a user type for that application. The assessment may focus on tests, defects, and user stories mapped to that user type. Referring to FIG. 3, assessment engine 84 may be responsible for block 150.

### CONCLUSION

FIGS. 1-6 aid in depicting the architecture, functionality, and operation of various embodiments. In particular, FIGS. 3-5 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 6 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for role based assessment for an IT management system, comprising:
maintaining a plurality of roles, each role attributable to a user type within an IT management system;
defining mappings between the plurality of user roles and assets of the IT management system; and
assembling an assessment for the IT management system from the perspective of a selected one of the plurality of roles based on a mapping between the selected user role and an asset of the IT management system.

2. The method of claim 1, wherein defining comprises defining an indirect mapping between a selected role and a selected asset by:
defining a mapping between the selected asset and a trait; and
defining a mapping between the selected role and the trait such that the shared mapping to the trait serves to indirectly map the selected role to the selected asset.

3. The method of claim 2, comprising maintaining a plurality of traits, the plurality including the mapped trait, wherein each of the plurality of traits corresponds to a characteristic attributable to a role of a user within the IT management system.

4. The method of claim 1, wherein defining comprises:
identifying a new or modified asset;
identifying other similar assets;
identifying shared mappings between the other similar assets and a particular role; and
at least one of suggesting a mapping between the new or modified asset and the particular role and automatically defining a mapping between the new or modified asset and the particular role.

5. The method of claim 4, wherein:
identifying shared mappings include identifying shared mappings between the other similar assets and a particular trait mapped to the particular role;
suggesting a mapping comprises suggesting a mapping between the new or modified asset and the particular trait; and
automatically defining comprises automatically defining a mapping between the new or modified asset and the particular trait.

6. A memory resource storing instructions that, when executed, cause a processing resource to implement a system for role based assessment for an IT management system, the instructions comprising:
a role module executable to maintain a plurality of roles each defining a type of user within an IT management system;
a trait module executable to maintain a plurality of traits each corresponding to a characteristic of a role maintained by role module;
a map module executable to define a plurality of mappings between assets managed by the IT management system, the plurality of roles, and the plurality of traits
wherein the plurality of mappings includes at least one of: a mapping between a selected one of the assets and a selected one for the roles, a mapping between a selected one of the assets and a selected one of the traits, and a mapping between a selected one of the roles and a selected one of the traits.

7. The memory resource of claim 6, wherein the map module is executable to define a direct mapping an indirect mapping between a first one of the assets and a first one of the roles by:
defining a mapping between the first one of the assets and a first one of the traits; and
defining a mapping between the first one of the roles and the first one of the traits.

8. The memory resource of claim 7, wherein the instructions include an assessment module executable to generate an assessment for the IT management system from the perspective of a selected one of the plurality of roles, the assessment including data associated with those of the assets that are mapped to the role directly or indirectly via a share mapping to common trait.

9. The memory resource of claim 8, wherein:
the IT management system is an application lifecycle management system;
the assets include, for a given application, at least one of a set of tests, a set of defects, and a set of user stories;
the assessment is an assessment of a quality of the application from the perspective of the selected one of the plurality of roles.

10. The memory resource of claim 6, wherein the map module is executable to define a mapping by:
examining existing mappings to identify mappings between a particular role or a particular trait and a set of similar assets
identifying an particular asset not mapped to the particular role or particular trait but having characteristics similar to the set; and
at least one of suggesting a mapping between the particular asset and the particular role or the particular trait and automatically defining a mapping between the particular asset and the particular role or the particular trait.

11. A system for role based assessment for an IT management system, the system comprising:
a role engine to maintain a plurality of roles, each role attributable to a user type within an IT management system;
a map engine to define mappings between the plurality of user roles and assets of the IT management system, at least one mapping having an associated weight;
an assessment engine to generate an assessment for the IT management system from the perspective of a selected one of the plurality of roles based on a mapping between the selected role and an asset of the IT management system the assessment and a weight associated with the mapping.

12. The system of claim 11, wherein the defined mappings include indirect mappings and wherein the map engine is configured to define an indirect mapping between a selected role and a selected asset by:
defining a mapping between the selected asset and a trait; and
defining a mapping between the selected role and the trait such that the shared mapping to the trait serves to indirectly map the selected role to the selected asset.

13. The system of claim 12, comprising a trait engine to maintain a plurality of traits, the plurality including the mapped trait, wherein each of the plurality of traits corresponds to a characteristic attributable to a role of a user within the IT management system.

14. The system of claim 11, wherein the map engine is configured to:
identify a new or modified asset;
identify other similar assets;
identify shared mappings between the other similar assets and a particular role; and
at least one of suggest a mapping between the new or modified asset and the particular role and automatically define a mapping between the new or modified asset and the particular role.

15. The system of claim 14, wherein the map engine is configured to:
identify shared mappings between the other similar assets and a particular trait mapped to the particular role;
suggest a mapping between the new or modified asset and the particular trait; and
automatically define a mapping between the new or modified asset and the particular trait.
